(19) United States
(12) Patent Application Publication
(10) Pub. No.: US 2013/0076901 A1
(43) Pub. Date: Mar. 28, 2013

(54) ON-SCREEN DISPLAY APPARATUS

(71) Applicants: Gyu Won Kim, Suwon (KR); Kyoung Joong Min, Seoul (KR); In Taek Song, Suwon (KR); Tae Hyeon Kwon, Gwangmyeong (KR)

(72) Inventors: Gyu Won Kim, Suwon (KR); Kyoung Joong Min, Seoul (KR); In Taek Song, Suwon (KR); Tae Hyeon Kwon, Gwangmyeong (KR)

(73) Assignee: SAMSUNG ELECTRO-MECHANICS CO.,LTD., Suwon (KR)

(21) Appl. No.: 13/331,349

(22) Filed: Dec. 20, 2011

(30) Foreign Application Priority Data
Sep. 27, 2011 (KR) 10-2011-0097389

(51) Int. Cl. H04N 7/18

(52) U.S. Cl. 348/148; 348/E07.085

(57) ABSTRACT

There is provided an on-screen display (OSD) apparatus including: a plurality of ultrasonic sensors having respective ranges previously assigned thereto to thereby detect an object therein; a camera module capturing an image of the ranges detected by the plurality of ultrasonic sensors; and a controlling unit controlling a display of positional information of the object detected in the ranges assigned to the plurality of individual ultrasonic sensors in the image captured by the camera module.

### CROSS-REFERENCE TO RELATED APPLICATIONS

This application claims the priority of Korean Patent Application No. 10-2011-0097389 filed on Sep. 27, 2011, in the Korean Intellectual Property Office, the disclosure of which is incorporated herein by reference.

### BACKGROUND OF THE INVENTION

1. Field of the Invention

The present invention relates to an on-screen display (OSD) apparatus processing an image, captured by a camera, of a view from the rear of a vehicle.

2. Description of the Related Art

An on-screen display (OSD) is generally implemented in an image such as a rearward image from a vehicle, or the like, such that various types of information may be displayed together therein. This display information may include a warning message indicating that an obstacle is positioned to the rear of a vehicle, a parking guideline serving as a guide at the time of backward movement of a vehicle, and the like. The parking guideline may include a static guideline statically displayed in the rear image, regardless of a direction of movement of a vehicle, a dynamic guideline displaying a projected parking guideline, according to a direction of movement of a vehicle, such as a curve, or the like.

In the case of this OSD apparatus, when an object is positioned to the rear of a vehicle, users may not be able to recognize exactly where the object to the rear of the vehicle is positioned, and exactly how distant from the rear of the vehicle the object is positioned.

### SUMMARY OF THE INVENTION

An aspect of the present invention provides anon-screen display (OSD) apparatus in which each of a plurality of ultrasonic sensors may display a distance to an object positioned at a corresponding range.

According to an aspect of the present invention, there is provided an on-screen display (OSD) apparatus including: a plurality of ultrasonic sensors having respective ranges previously assigned thereto to thereby detect an object therein; a camera module capturing an image of the ranges detected by the plurality of ultrasonic sensors; and a controlling unit controlling a display of positional information of the object detected in the ranges assigned to the plurality of individual ultrasonic sensors in the image captured by the camera module.

The controlling unit may include a determinator dividing the ranges of the captured image and determining a position of the object in the captured image according to the positional information of the object detected in the ranges assigned to the plurality of individual ultrasonic sensors; and a controller controlling the dividing of the ranges and the determining of the position performed by the determinator.

The determinator may include an image divider dividing the captured image into the ranges assigned to the plurality of individual ultrasonic sensors; a range and distance determinator determining the ranges assigned to the plurality of individual ultrasonic sensors and the position of the detected object in the captured image; and a color determinator determining a color of a bitmap image for OSD according to the positional information of the detected object.

The controller may store pixel data of the bitmap image for OSD therein.

The controller may determine active pixel data that is combined with the determined image from the determinator among the pixel data of the stored bitmap image for OSD.

The controller may combine the active pixel data with the determined image from the determinator to thereby output a final image.

The controller may alternately set the active pixel data and inactive pixel data that is not combined with the determined image in horizontal and vertical directions of the stored bitmap image for OSD.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view of the configuration of an on-screen display (OSD) apparatus according to an embodiment of the present invention;

FIG. 2 is a flowchart showing the operation of an OSD apparatus according to an embodiment of the present invention;

FIG. 3 is a view of the operation of an OSD apparatus according to an embodiment of the present invention;

FIG. 4 is a view of an image synthesized by an OSD apparatus according to an embodiment of the present invention;

FIG. 5 is examples of pixel data for image synthesis in an OSD apparatus according to an embodiment of the present invention;

FIG. 6 is a signal diagram, through which an image is output for image synthesis in an OSD apparatus according to an embodiment of the present invention;

FIG. 7 is a lookup table for image synthesis in an OSD apparatus according to an embodiment of the present invention; and

FIG. 8 is a view of range division of an OSD apparatus according to an embodiment of the present invention.

### DETAILED DESCRIPTION OF THE PREFERRED EMBODIMENT

Embodiments of the present invention will now be described in detail with reference to the accompanying drawings.

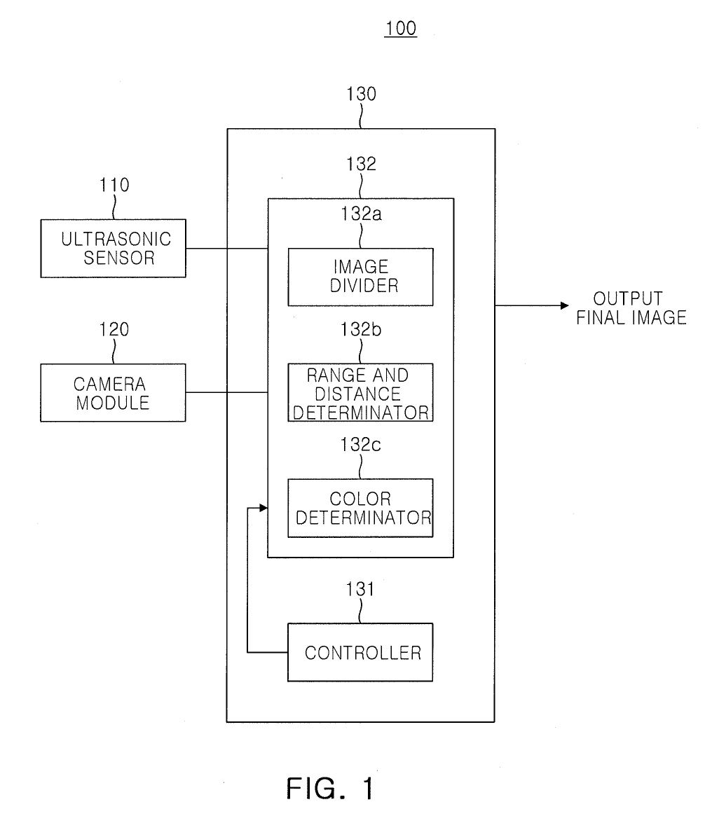

FIG. 1 is a schematic view of the configuration of an on-screen display (OSD) apparatus according to an embodiment of the present invention.

Referring to FIG. 1, an OSD apparatus 100 according to an embodiment of the present invention may include an ultrasonic sensor 110, a camera module 120, and a controlling unit 130.

A plurality of ultrasonic sensors 110 may be provided. Each of the plurality of ultrasonic sensors 110 may have a preset range previously assigned thereto to thereby transmit ultrasonic waves within its corresponding range and receive reflected ultrasonic waves.

The camera module 120 may image the entirety of the preset ranges to thereby obtain an image of the preset ranges.

The entirety of the preset ranges assigned to the plurality of ultrasonic sensors 110 may be within the image captured by the camera module 120.

The controlling unit 130 may synthesize the image captured by the camera module 120 with positional information detected by the plurality of ultrasonic sensors 110 to thereby output a final image.

To this end, the controlling unit 130 may include a controller 131 and a determinator 132.

The controller 131 may control image processing determination of the determinator 132 and store pixel data of a bitmap image for OSD.

That is, the controller 131 may determine active pixel data that is combined with the determined image from the determinator 132 among the pixel data of the stored bitmap image for OSD, and may combine the active pixel data with the determined image from the determinator to thereby output a final image.

Therefore, the controller 131 may alternately set the active pixel data and inactive pixel data that is not combined with the determined image in horizontal and vertical directions of the stored bitmap image for OSD.

The determinator 132 determines information to be synthesized with the captured image. To this end, the determinator 132 may include an image divider 132a, a range and distance determinator 132b, and a color determinator 132c.

The image divider 132a may divide the captured image into the ranges assigned to the plurality of individual ultrasonic sensors 110.

The range and distance determinator 132b may determine a distance to an object detected in the ranges assigned to the plurality of individual ultrasonic sensors 110 in the captured image.

The color determinator 132c may determine a color displaying the distance to the detected object.

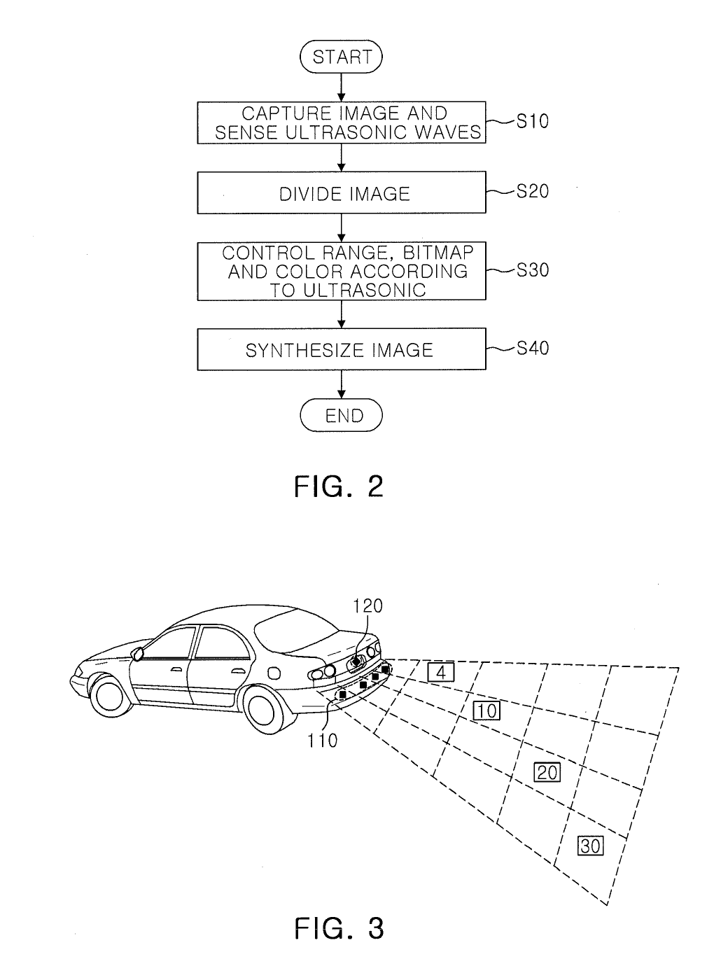

FIG. 2 is a flowchart showing the operation of an OSD apparatus according to an embodiment of the present invention.

Referring to FIGS. 1 and 2, the OSD apparatus 100 according to the embodiment of the present invention allows the camera module 120 to image the preset ranges. The plurality of ultrasonic sensors 110 may detect an object in corresponding ranges (S10).

The image divider 132a of the determinator 132 may divide the captured image into the ranges based on a lookup table shown in FIG. 7.

Predetermined values may be stored in the lookup table. First, a distance from a point within the preset range to a straight line may be calculated using a linear equation as represented by the following Equation 1:

$$d = \frac{\vert {ax}_{1} + {by}_{1} + c \vert}{\sqrt{{a}^{2} + {b}^{2}}} \qquad ( Equation 1 )$$

The linear equation is calculated by setting a desired position in the captured image as a reference point, and values (Row, Column) are calculated using distances from the straight line calculated by the linear equation to straight lines dividing the preset ranges, whereby values of the individual ranges may be stored in the lookup table.

The following Equations 2 and 3 may show an example of dividing the image into the ranges by vertically and horizontally reading values from the lookup table (S20).

inc_width1=row_inc

position_{—}w1+start+inc_width1

position_{—}w2=position_{—}w1+inc_width2

position_{—}wn=position_{—}wn−1+inc_width_{—}n (Equation 2)

inc_height1=colum_inc

position_{—}h1+start+inc_height1

position_{—}h2=position_{—}h1+inc_height2

position_{—}hn=position_{—}hn−1+inc_height_{—}n (Equation 3)

Meanwhile, in the case of a camera for an electrical device, a wide angle camera lens is used in order to image a wide area. Therefore, a slight difference may be generated between the ranges of the image and a reaction distance of the ultrasonic sensors. In order to display an accurate position and range of the object, the ranges are divided using the following Equation.

Range=rear bumper range/number of sensor (Equation)

Where Range means that the rear bumper ranges of a vehicle are equally divided according to the number of sensors. When the ranges are divided in an x-axis, y-axis ranges are also divided using the following Equation.

FIG. 8 is a view of range division of an OSD apparatus according to an embodiment of the present invention.

Referring to FIG. 8, ΔTi means a length of a blind spot that is not viewed from an angle of view (180°−2θ) of a wide angle lens. ΔKi means an amount of change in length information obtained by being reflected from an ultrasonic sensor.

A distance value is calculated by actually measuring and calculating a distance occupied by a single pixel using an image captured by a camera module. The distance (scope) calculated in the image as described above is matched to Y_value as in the following Equation to thereby be displayed on a screen.

Y_value 1=ΔTi+ΔKi (Equation)

Next, the distance value between the plurality of ultrasonic sensors 110 and the object detected by the plurality of ultrasonic sensors 110 and a corresponding ultrasonic sensor number may be transferred to the controlling unit 130.

FIG. 3 is a view of the operation of an OSD apparatus according to an embodiment of the present invention. As shown in FIG. 3, the OSD apparatus according to the embodiment of the present invention may include the camera module 120 and the plurality of ultrasonic sensors 110 mounted on the rear of the vehicle to thereby image a view of the rear of the vehicle and detect distances to an object in the ranges assigned to the plurality of ultrasonic sensors 110. Here, four ultrasonic sensors may be employed and may be numbered 1 to 4, respectively.

The range and distance determinator 132b may select the divided ranges of the image and read a bitmap for OSD stored in the controller 131 using a distance value from a corresponding ultrasonic sensor.

The color determinator 132c may determine a corresponding color using the distance value (530). FIG. 5 is examples of pixel data for image synthesis in the OSD apparatus according to the embodiment of the present invention.

That is, the ranges of the image captured by the camera module 120 may be divided vertically and horizontally by the number of the ultrasonic sensors 110 using the values of the lookup table.

Based on the ranges divided as described above, when the distance between the ultrasonic sensor and the object and the corresponding ultrasonic sensor number are transferred to the controlling unit 130, the range and distance determinator 132b selects a range of the image, divided using the corresponding ultrasonic sensor number and the measured distance.

The color determinator 132c may read a color of a bitmap image for OSD stored in the controller 131 in the selected range to thereby determine a color of the corresponding range.

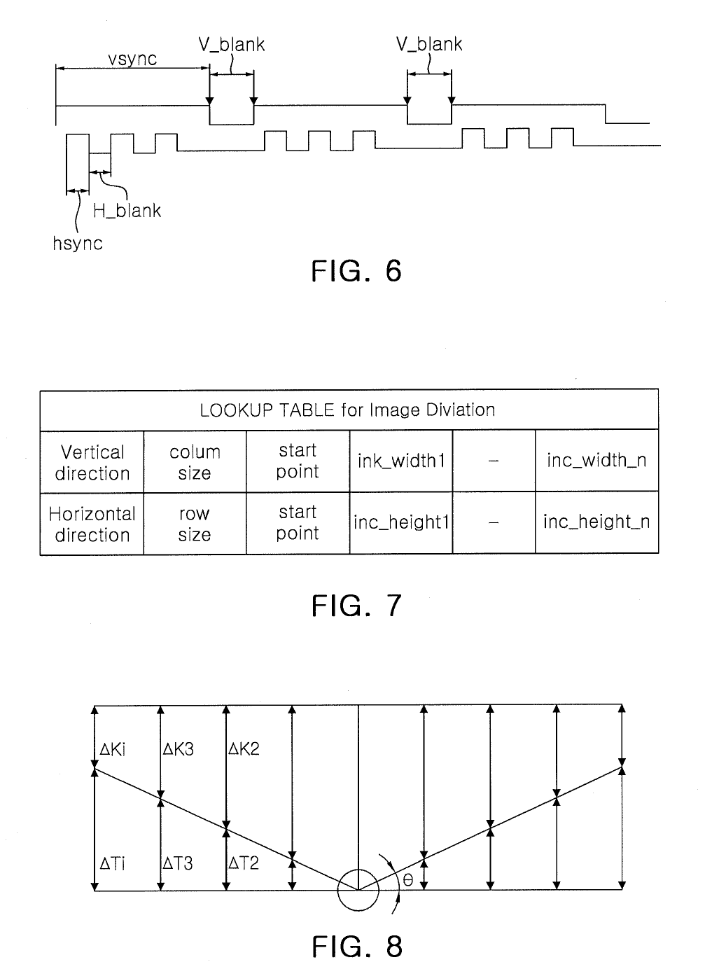

FIG. 6 is a signal diagram, through which an image is output for image synthesis in an OSD apparatus according to an embodiment of the present invention. The controller 131 may determine even and odd ranges of the captured image according to the following Equations 4 through 8 to thereby overlap the captured image and the bitmap image for OSD with each other.

(vsync==1)?hcnt=hcnt1:hcnt+0;

(hsync==1)?hcnt_{—}i−hcnt+1:hcnt_{—}i=0; (Equation 4)

Where vsync indicates the entire image output period, hsync indicates a Row output period of the image, and hcnt indicates the number of pixels.

Bitmap Point Even_{—}1=Even row+N (Equation 5)

Bitmap Point Even_{—}n=Bitmap Point Even_(n−1)+N (Equation 6)

Where Bitmap Point Even_1 indicates a corresponding pixel position of an even range in an image column, and N indicates a distance between pixels.

Bitmap Point Odd_{—}1=Odd row+N (Equation 7)

Bitmap Point Odd_{—}n=Bitmap Point Odd_(n−1)+N (Equation 8)

Where Bitmap Point Odd_1 indicates a corresponding pixel position of an odd range in an image column, and N indicates a distance between pixels.

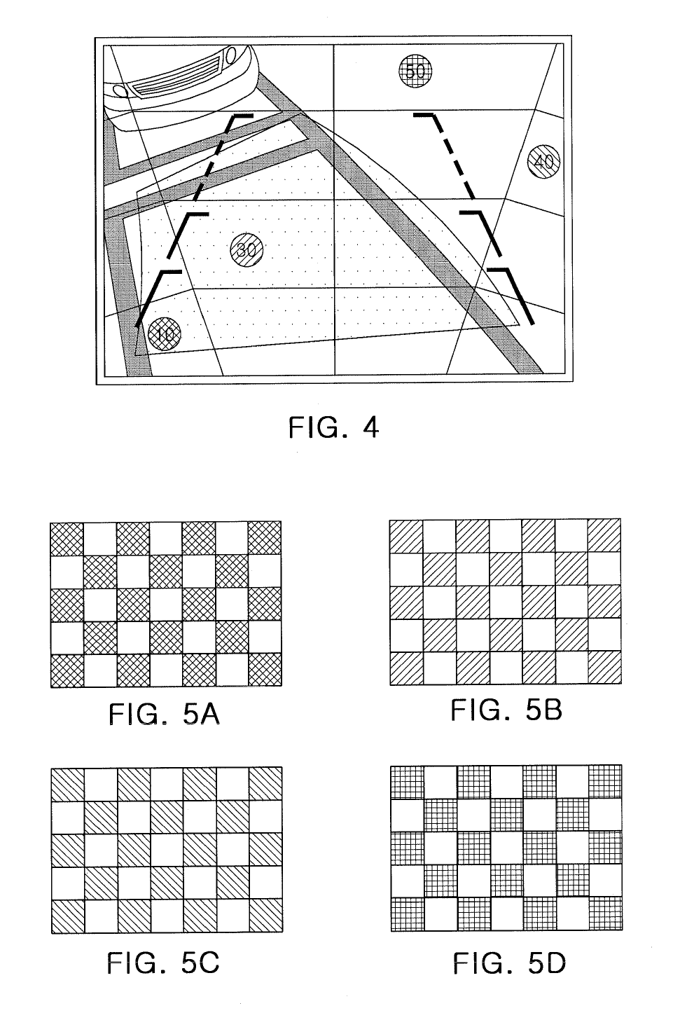

The image overlap is performed in the order of the captured image and the bitmap image for OSD or in the order of the bitmap image for OSD and the captured image, whereby the distance between the image of the rear of the vehicle and the detected object may be displayed for each range assigned to each ultrasonic sensor as shown in FIG. 4 while a blind phenomenon of the image is prevented.

FIG. 4 is a view of an image synthesized by an OSD apparatus according to an embodiment of the present invention. Here, vertically and horizontally divided lines may or may not be displayed.

As set forth above, according to embodiments of the present invention, each of a plurality of ultrasonic sensors displays a distance to an object positioned in a corresponding range. When the object is positioned at the rear of a vehicle, a user may be informed of exactly where and how distant the object to the rear of the vehicle is positioned therefrom. In addition, an influence of a bitmap image on a display image at the time of image synthesis may be minimized.

While the present invention has been shown and described in connection with the embodiments, it will be apparent to those skilled in the art that modifications and variations can be made without departing from the spirit and scope of the invention as defined by the appended claims.

What is claimed is:

1. An on-screen display (OSD) apparatus, comprising:
a plurality of ultrasonic sensors having respective ranges previously assigned thereto to thereby detect an object therein;
a camera module capturing an image of the ranges detected by the plurality of ultrasonic sensors; and
a controlling unit controlling a display of positional information of the object detected in the ranges assigned to the plurality of individual ultrasonic sensors in the image captured by the camera module.

2. The apparatus of claim 1, wherein the controlling unit includes:
a determinator dividing the ranges of the captured image and determining a position of the object in the captured image according to the positional information of the object detected in the ranges assigned to the plurality of individual ultrasonic sensors; and
a controller controlling the dividing of the ranges and the determining of the position performed by the determinator.

3. The apparatus of claim 2, wherein the determinator includes:
an image divider dividing the captured image into the ranges assigned to the plurality of individual ultrasonic sensors;
a range and distance determinator determining the ranges assigned to the plurality of individual ultrasonic sensors and the position of the detected object in the captured image; and
a color determinator determining a color of a bitmap image for OSD according to the positional information of the detected object.

4. The apparatus of claim 3, wherein the controller stores pixel data of the bitmap image for OSD therein.

5. The apparatus of claim 4, wherein the controller determines active pixel data that is combined with the determined image from the determinator among the pixel data of the stored bitmap image for OSD.

6. The apparatus of claim 5, wherein the controller combines the active pixel data with the determined image from the determinator to thereby output a final image.

7. The apparatus of claim 6, wherein the controller alternately sets the active pixel data and inactive pixel data that is not combined with the determined image in horizontal and vertical directions of the stored bitmap image for OSD.
